(19) United States
(12) Patent Application Publication
(10) Pub. No.: US 2009/0188694 A1
(43) Pub. Date: Jul. 30, 2009

(54) FLEXIBLE CONDUIT WITH VISUAL IDENTIFICATION

(75) Inventors: Robert Pereira, Rochester, MA (US); Paul Picard, East Greenwich, RI (US); Joseph D. Colangelo, Chepachet, RI (US); Marilou Newell, Mattapoisett, MA (US)

Correspondence Address: Tyco International Management Corp., 9 Roszel Road, Princeton, NJ, 08540, US

(73) Assignee: WPFY, INC., Wilmington, DE (US)

(21) Appl. No.: 12/358,443

(22) Filed: Jan. 23, 2009

Related U.S. Application Data
(60) Provisional application No. 61/023,696, filed on Jan. 25, 2008.

(51) Int. Cl. H01B 7/36; B23P 19/00

(52) U.S. Cl. 174/112; 29/745

(57) ABSTRACT

An electrical conduit having a flexible metal tubular structure having an outer sheathing and an interior hollow area. An electrical conductor is housed in the interior hollow area. A visible indicia is applied to the outer sheathing and extends along at least a portion of the metal tubular structure where the visible indicia corresponds to at least one characteristic of the conduit or electrical conductor housed therein.

### CROSS-REFERENCE TO RELATED APPLICATIONS

This application claims priority to U.S. Provisional Application No. 61/023,696 filed Jan. 25, 2008 which is incorporated herein by reference in its entirety.

### BACKGROUND

1. Field of the Invention

Embodiments of the invention relate to the field of electrical conduit and connections. More particularly, the present invention relates to a visual indicia included as an identification system for electrical conduit.

2. Discussion of Related Art

In the construction industry, electrical wires are often run through piping to safely deliver power to and from a panel and then onto different areas of a building or structure. This piping, referred to as “conduit” in the trade, is typically constructed from metal or plastic and comes in a variety of sizes standard to the electrical industry to satisfy building codes as set forth, for example in the National Electric Codes (NEC). Generally, conduit refers to a product in which the electrical conductors are not installed until after the conduit is installed. Conversely, cable refers to conduit in which the electrical conductors are installed during manufacture. The size and type of conduit used to run a particular electrical line depends both upon the length of the run, particular power requirements, and protection needed for the application. Various types of conduit are configured to provide moisture, chemical, heat and impact protection for the conductors installed therein. For example, conduit may be used in factories and processing plants in which highly corrosive materials and chemicals are used which may compromise the electrical characteristics of exposed conductors. The conduit may be rigid and formed by seam welding sheet metal of a particular thickness and composition. Particular lengths and shapes are cut to size before installation. However, flexible conduit is more frequently used in residential and commercial wiring applications because of the versatility imparted by the flexible nature of the conduit.

Flexible conduit is formed by helically winding steel or aluminum to form an armored sheath. When installed, the flexible conduit is supplied from a coil or reel and cut to appropriate lengths. Electrical conductors are then pulled through the installed conduit to provide power within the structure for various applications. The ends of the conduit are attached to electrical (junction) boxes and connections are made among the conductors within the boxes as well as to electrical fixtures. In this manner, the conduit provides mechanical protection of the electrical conductors while enabling them to be bent around corners and the like for relatively easy and fast installation. However, a typical wiring job may require various types of conduits and/or electrical conductors installed within the conduit. Once the conductors are pulled through the conduit, the type of conductors contained in the conduit and the application of the conduit itself may only be determined by tracing the conduit back to a junction box or electrical panel which is time consuming and labor intensive.

### SUMMARY OF THE PRESENT INVENTION

Exemplary embodiments of the present invention are directed to an apparatus and method for color coded electrical conduit. In an exemplary embodiment, the conduit includes a flexible metal tubular structure having an outer sheathing and an interior hollow area. A visual indicia is applied to the outer sheathing and extends along at least a portion of the metal tubular structure. The visual indicia corresponds to at least one characteristic of the conduit. The visual indicia, for example color coding, provides an identification system for designating various characteristics of the conduit and/or the electrical conductors housed within the hollow area.

### BRIEF DESCRIPTION OF THE DRAWINGS

FIG. 1 is a side view of an exemplary flexible conduit in accordance with the present invention;

FIG. 1A is a side view of an exemplary flexible conduit having a visible indicia in accordance with the present invention;

FIG. 2 is a side view of an exemplary extra-flexible conduit having a visible indicia in accordance with the present invention

FIG. 3 is a flow chart illustrating the steps associated with forming an exemplary flexible conduit in accordance with the present invention.

FIG. 4 is a schematic illustration of an exemplary machine used to carry-out the process for forming flexible conduit in accordance with the present invention.

### DESCRIPTION OF EMBODIMENTS

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

The present invention is an identification system for designating various characteristics of electrical conduit. The identification system may include, for example, a visible indicia comprising color coding the exterior surface of the electrical conduit to indicate a characteristic thereof associated with or for a particular purpose. The conduit may be constructed from steel, aluminum, copper, bronze, stainless steel, etc., with the specific metal determinable for the particular use. The color coating may include any one or combinations of one or more colors to visually indicate the characteristic(s) of the conduit. As used herein, characteristics signify the purpose or use of the conduit in a given environment particularly within the electrical arts such as wiring for buildings. Metallic conduit used within the building industry has specialized functions that need immediate recognition for safety. Representative characteristics include, for example, electrical circuit identification, conduit size, type of conduit, specific applications for the conduit as defined in the National Electrical Code and combinations thereof. Generally, the characteristics of a conduit are indicated by forming a flexible metal conduit with a visible indicia and designating a characteristic of the conduit relative to the particular form or combination of indicia.

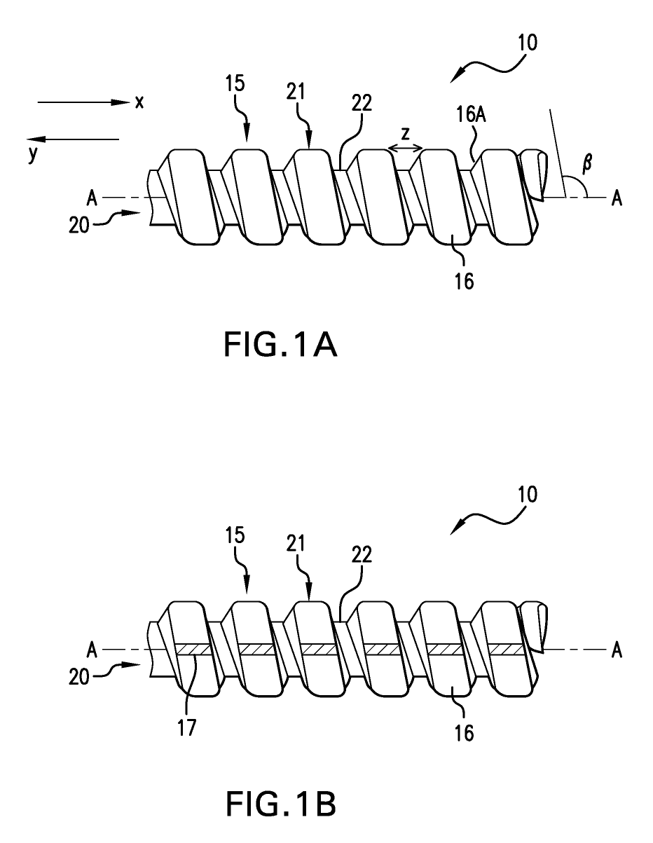

FIG. 1 illustrates a side view of a representative flexible metal conduit 10. Although flexible metal conduit is disclosed herein, alternative embodiments including rigid conduit having a relatively smooth exterior surface may also be employed. Conduit 10 is essentially a tube having an outer surface or sheathing 15 and an inner hollow area 20 which runs the length of the conduit. Depending on the particular application, the conduit may form an air and liquid tight environment. The conduit forms a raceway for the installation of electrical conductors or wires which are pulled through the hollow area from location to location within a building or other structure. Exemplary conduit 10 is formed from interlocking sections 16 of arcuate members which present a continuous surface 15 of alternating crowns 21 and troughs 22 on both the exterior and interior walls thereof to form a strong, bendable conduit. The plurality of windings 16 are formed from a helically interlocked continuous strip of steel, aluminum or alternative materials. Troughs 22 may form spaces separating each of the windings a distance z from an adjacent winding 16.

Aluminum conduit is typically used in corrosive environments such as processing plants where the electrical conductors are protected from various liquids including harmful chemicals that may compromise the electrical characteristics of the conductors. Aluminum is lighter in weight than a similarly sized steel conduit, but is more expensive to manufacture. It is important to note that such aluminum conduit is not appropriate for concrete applications since the aluminum reacts with the alkalis in cement thereby breaking down the protective properties of the conduit. Conduit 10 may also be made from steel and have various wall thicknesses for various applications. For example, heavier grades of steel conduit may be used for exposed conduit installations where increased crush an/or impact resistance is needed while thin walled conduit may only be suitable for hidden or less trafficked areas or in areas with less potential for damage. In addition, full wall steel conduit includes heavier metal and is required for CSA applications. Full wall steel may also be made from high grade zinc galvanized low carbon steel. Reduced wall conduit uses a thinner metal for example, but which meets the same performance specifications. Reduced wall conduit may be made from high grade hot dipped zinc galvanized low carbon steel.

Conduit 10 has a central longitudinal axis A. Each of the plurality of windings 16 are formed at an angle β with respect to the central axis A. In particular, this angle β reduces the pulling force needed when installing the conduit within walls or around certain obstacles for example studs or beams, HVAC equipment, piping and plumbing within a building or structure. For example, flexible conduit 10 may be positioned through, in, and between various structural obstacles encountered during installation. The angle of the windings along the entire length of the conduit allows the conduit to be pulled in direction X more easily than in the opposite direction Y. Each of the portions 16A of windings 16 are angled downward from each crown 21 around conduit 10. This configuration of each portion 16A also assists in reducing the required pulling force during installation. In addition, the type of material used to form conduit 10 will influence its weight and consequently the pulling force required to install the conduit and materials used to suspend or attach the conduit in place. A typical wiring job may require various types of electrical conductors installed within conduit 10 as well as a plurality of large and small gauge electrical conductors. Previously, once the conductors are pulled through conduit 10, the type of conductors and application may only be determined by tracing the conduit back to a junction box or electrical panel.

A visual indicia, for example a color coded system is disclosed herein which is used to identify the type of conduit as well as its associated application, e.g. lighting, fire and security alarms, HVAC, communications etc. Conduit 10 is marked with a particular color ink or paint in a pattern to indicate the application and/or type of conductors housed within the conduit. The color coding ink is applied to sheathing 15 and may be applied to portions of one or more windings 16 to provide a clear indication of the purpose of the conduit and/or the electrical conductors housed therein. For example, FIG. 1A shows an exemplary marking 17 applied to each of the windings 16 along the length of or a partial length of conduit 10. Marking 17 is illustrated as a stripe which is aligned along axis A of conduit 10. Again, this is illustrated only as an example and the identification marking may be any one of a plurality of different patterns and colors. The ink or paint may be applied helically around the perimeter of conduit 10, longitudinally along the length of conduit 10, a portion of the conduit in proximity to particular fixtures and/or junction boxes as well as marked continuously and/or intermittently along specific sections of conduit 10 all to provide easy visual indication for a particular application or multiple applications. The color coding may be selected from a plurality of colors or combination of colors. For example, one color (e.g. red) or a combination of colors may indicate electrical conductors used to provide power for a fire alarm system. Another color or a combination of colors may indicate conduit which houses telecommunications cables. Another color or a combination of colors may indicate conduit which houses electrical conductors for lighting systems. Another color or a combination of colors may indicate conduit which houses electrical conductors for HVAC systems. Because conduit 10 may be suspended from ceilings or positioned high on a wall, the ink and particular colors selected for identification must be clearly visible at various heights and distances. In addition, conduit 10 may be installed in process plants where various conditions may make it difficult to see. In these situations, the identifying markings may be applied in multiple locations or continuously along the length of conduit 10 to make it easy to locate and identify. In this manner, the different colors and type of ink or paint used allows quick and easy visual identification of conduit associated with a particular application. The color coding ink or paint can be conductive or not applied to portions of the conduit sheathing 15 which come in contact with connectors used to attach the housed conductors to electrical panels or boxes which may otherwise jeopardize the conductivity of the electrical path if applicable. The paint or ink may be applied to portions of conduit 10 which are visible and easily traceable along the installation path within a building or structure.

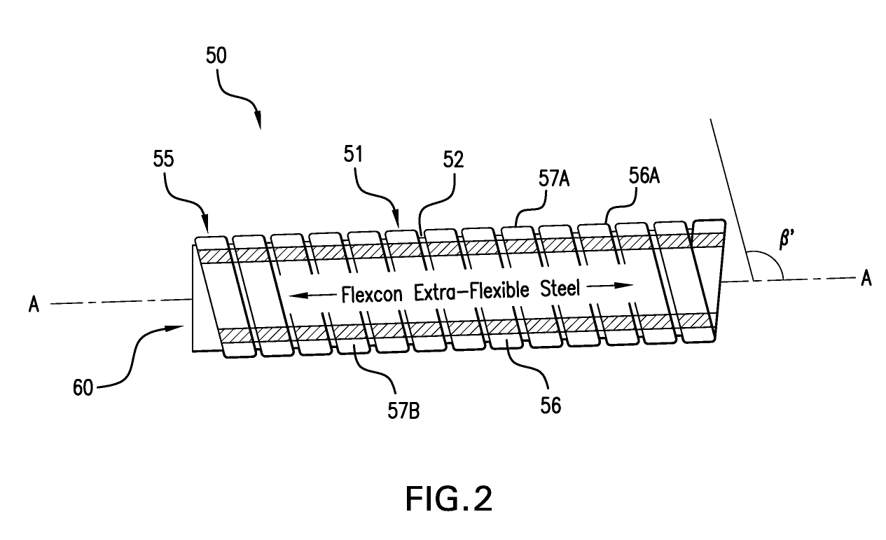

FIG. 2 illustrates conduit 50 which is more flexible than conduit 10 shown in FIGS. 1 and 1A. Conduit 50 is a tube having an outer surface or sheathing 55 and an inner hollow area 60 which runs the length of the conduit. The inner hollow area 60 forms a raceway for the installation of electrical conductors or wires which are pulled through the tube. Conduit 50 includes a central axis A and a plurality of windings 56 configured around the central axis which define a series of crowns 51 and troughs 52 to form a strong, bendable conduit. The spacing between windings 56 (i.e. the depth of troughs 52) provides more windings per unit length than that shown with reference to conduit 10 in FIG. 1 as well as shallower troughs 52. The shallower troughs are the result of a flatter profile of portions 56A of windings 56 which also lessens the required pulling force. The combination of the increased number of windings and the shallower profile allows conduit 50 to have a tighter bend radius within a given unit area or space. This sharper or tighter bend radius adds to the cost of conduit 50 because of the greater material and labor required to manufacture. Each of the plurality of windings 56 is formed at an angle β′ with respect to the central axis A. In particular, this angle β′ reduces the pulling force needed when installing the conduit within walls or around certain obstacles for example studs, HVAC equipment, piping and plumbing within a building or structure.

Conduit 50 is marked with a particular color ink or paint in a pattern to indicate the application and/or type of conductors housed within the conduit. The color coding ink or paint is applied to sheathing 55 and may be applied to portions of one or more windings 56 to provide a clear indication of the purpose of the conduit and/or the electrical conductors housed therein. FIG. 2 shows an exemplary markings 57A and 57B applied along the length of or a partial length of conduit 50. Markings 57A and 57B form a first and second stripe, aligned with axis A of conduit 50. Again, this is illustrated as an example and the identification markings may be any one of a plurality of different patterns and colors. The ink or paint may be applied helically around the perimeter of conduit 50, longitudinally along the length of conduit 50, to a portion of the conduit in proximity to particular fixtures and/or junction boxes as well as marked continuously and/or intermittently along specific sections of conduit 50 all to provide easy visual indication for a particular application or multiple applications. The color coding may be selected from a plurality of colors or combination of colors.

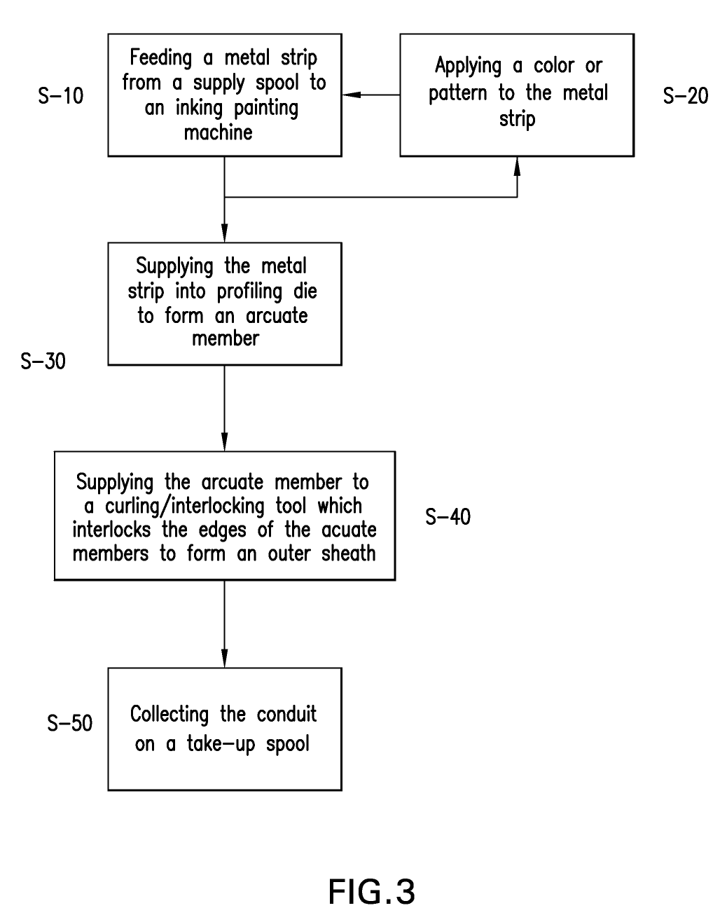

FIG. 3 illustrates a flow chart illustrating a method of manufacturing the electrical conduit having a visual indicia thereon. In particular, a metal strip is fed from a supply spool to an inking or painting application machine at step S10. The application machine applies the ink or paint to the metal strip in accordance with the color and pattern to indicate a desired characteristic(s), for example, gauge and application, gauge and phase, etc. If additional patterns or colors are desired, the metal strips may be supplied again to the application machine or to an additional pattern machine at step S20. At step S30, the metal strip with the visual indicia is fed into a profiling die which forms the strip into an arcuate member. The arcuate member may, for example, have an ‘S’ or ‘Z’ shape. The arcuate members are then supplied to a curling/interlocking tool which interlocks the edges of the arcuate members to form an outer sheath at step S40. The hollow area within the outer sheath forms the raceway through which electrical conductors are pulled. The conduit formed after the profiling machine is then collected on a take-up spool at step S50 and transported.

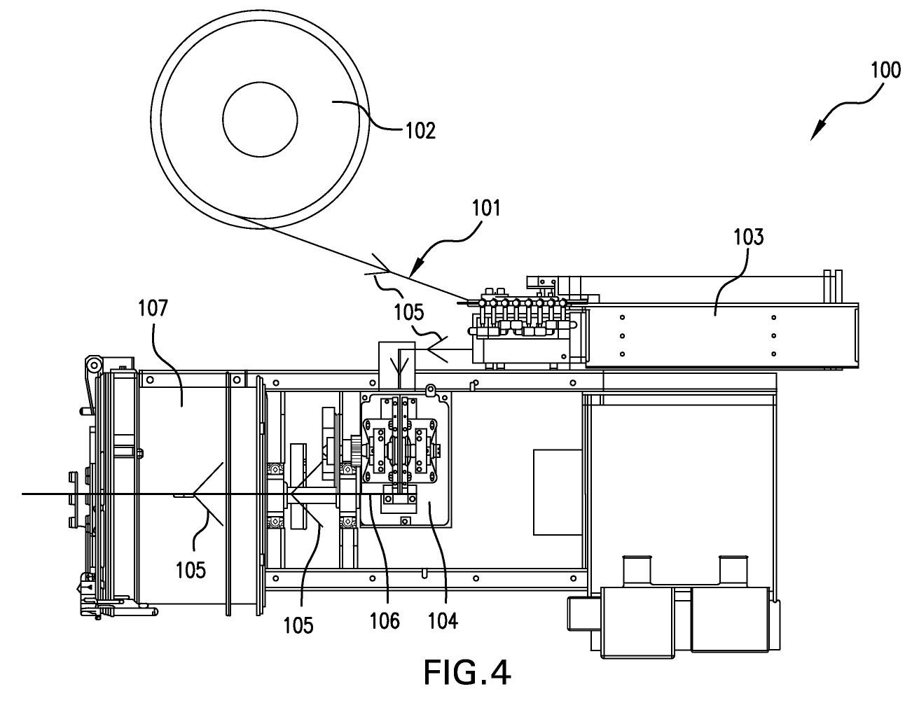

FIG. 4 is a schematic illustration of an exemplary machine line 100 used to carry-out the process for forming flexible conduit as shown in FIG. 3. In particular, strips of steel, aluminum or the like, 101 are supplied from supply spool or payoff roll 102 to a paint/ink applicator 103. A color and/or pattern is applied to the metal strip 101 and fed to profile die and curling tool 104 in the direction of arrows 105. Profile die 104 forms an arcuate member 106 from the metal strip 101 into, for example, an S or Z configuration. The arcuate member 106 is then supplied to a conduit take-up or collecting spool 107.

While the present invention has been disclosed with reference to certain embodiments, numerous modifications, alterations and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. An electrical conduit comprising:
a flexible metal tubular structure having an outer sheathing and an interior hollow area; and,
a visible indicia applied to the outer sheathing and extending along at least a portion of said metal tubular structure, said visible indicia corresponding to at least one characteristic of said conduit.

2. The electrical conduit of claim 1, wherein the metal tubular structure comprises a steel composition.

3. The electrical conduit of claim 1, wherein the metal tubular structure comprises an aluminum composition.

4. The electrical conduit of claim 1, wherein the visible indicia comprises one or more colors.

5. The electrical conduit of claim 1 wherein said visible indicia comprises a particular pattern.

6. The electrical conduit of claim 5, wherein said visible indicia is a applied to said outer sheathing using paint.

7. The electrical conduit of claim 5, wherein said visible indicia is a applied to said outer sheathing using ink.

8. The electrical conduit of claim 1, wherein the characteristic of the conduit is selected from the group consisting of electrical circuit identification, conduit size, type of conduit, specific applications for the conduit as defined in the National Electrical Code and combinations thereof.

9. The electrical conduit of claim 1 wherein said flexible metal tubular structure comprises a plurality of interlocking sections of arcuate members.

10. The electrical conduit of claim 9 further comprising a central axis along said hollow area, each of said interlocking sections being angled with respect to said central axis.

11. A method comprising:
providing a tubular structure having an outer sheathing and an interior hollow area, said tubular structure having a first end and a second end,
applying a visible indicia to at least a portion of said outer sheathing; and
pulling an electrical conductor through said interior hollow area from said first end to said second end, wherein said visible indicia corresponding to at least one characteristic of said electrical conductor.

12. The method of claim 11 wherein said tubular structure is flexible.

13. The method of claim 11 wherein said visible indicia comprises one or more colors.

14. The method of claim 11 wherein said visible indicia comprises a particular pattern.

15. A method for forming a flexible metal conduit having a visual indicia comprising:
feeding a metal strip from a supply spool to an application machine;
applying a visual indicia to said metal strip;
providing said metal strip with said visual indicia to a profile machine to form a plurality of arcuate members; and
interlocking the plurality of arcuate members such that a helically wound outer sheathing is formed.
